(19) United States
(12) Patent Application Publication
(10) Pub. No.: US 2011/0261497 A1
(43) Pub. Date: Oct. 27, 2011

(54) DEVICE FOR PRODUCING A MAGNETIC FIELD AND ADJUSTING THE INTENSITY OF THE MAGNETIC FIELD

(75) Inventor: TAO HE, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/916,588

(22) Filed: Oct. 31, 2010

(30) Foreign Application Priority Data
Apr. 23, 2010 (CN) 201010153584.8

(51) Int. Cl. H01H 47/22

(52) U.S. Cl. 361/152

(57) ABSTRACT

A device for producing a magnetic field and adjusting the magnetic field's intensity includes a power source, a wire winding, a path switching module, a path control module, a first adjusting module, and a second adjusting module. The path switching module is electrically connected between the power source and the wire winding. The path control module controls the wire winding and the power source to form a first loop to produce a first magnetic field or a second loop to produce a second magnetic field by controlling the path switching module. The first adjusting module is located in the first loop and adjusts the intensity of the first magnetic field by adjusting current flowing through the first loop. The second adjusting module is located in the second loop and adjusts the intensity of the second magnetic field by adjusting current flowing through the second loop.

### BACKGROUND

1. Technical Field

The present disclosure relates to devices for producing a magnetic field and, particularly, to a device for producing a magnetic field and adjusting the intensity of the magnetic field produced by it.

2. Description of Related Art

Nowadays, more and more electronic devices, such as mobile phones, are equipped with an electronic compass to provide a navigation function. In order to guarantee the quality of the electronic compass, a related test is needed before manufacturing is completed. An electronic compass can execute navigation functions by detecting the magnetic field of the earth, therefore, it is needed to provide a magnetic field to test the electronic compass. The usual method is to use a magnet to produce the magnetic field, however, the intensity of the magnetic field produced by the magnet cannot be changed easily, therefore some functions such as the sensitivity of the electronic compass cannot be tested.

Therefore, it is desirable to provide a device that produces a magnetic field and adjusts the magnetic field's intensity to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a device for producing and adjusting magnetic field, in accordance with an exemplary embodiment.

FIG. 2 is a circuit diagram of the device of FIG. 1, in accordance with an exemplary embodiment.

### DETAILED DESCRIPTION

Embodiments of the present disclosure will now be described in detail below, with reference to the accompanying drawings.

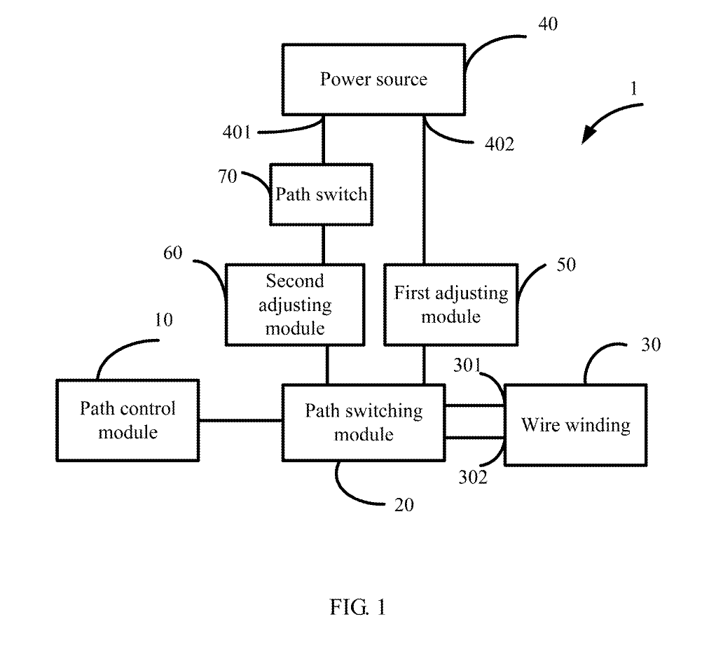

Referring to FIG. 1, a device 1 that produces a magnetic field and adjusts the intensity of the magnetic filed is provided in accordance with an exemplary embodiment. The device 1 includes a path control module 10, a path switching module 20, a wire winding 30, and a power source 40.

The path switching module 20 is electrically connected between the wire winding 30 and the power source 40. The path control module 10 controls the path switching module 20 to switch the connection between the power source 40 and the wire winding 30 to cause the wire winding 30 and the power source 40 to form a first loop or a second loop. In the embodiment, when the first loop is formed, the wire winding 30 produces a first magnetic field, when the second loop is formed, the wire winding 30 produces a second magnetic field. The wire winding 30 includes a first terminal 301 and a second terminal 302. When the wire winding 30 and the power source 40 form the first loop, the first terminal 301 and the second terminal 302 are respectively connected to an anode 401 and a cathode 402 of the power source 40. The current flows through the wire winding 30 from the first terminal 301 to the second terminal 302, then the wire winding 30 produces the first magnetic field. When the wire winding 30 and the power source 40 form the second loop, the first terminal 301 and the second terminal 302 are respectively connected to the cathode 402 and the anode 401 of the power source 40. The current flows through the wire winding 30 from the second terminal 302 to the first terminal 301, then the wire winding 30 produces the second magnetic field.

The device 1 further includes a first adjusting module 50 and a second adjusting module 60. The first adjusting module 50 is electrically connected between the path switching module 20 and the cathode 402 of the power source 40, the second adjusting module 60 is electrically connected between the path switching module 20 and the anode 401 of the power source 40. When the wire winding 30 and the power source 40 form the first loop, the first adjusting module 50 is located in the first loop and adjusts the current flowing through the first loop thereby adjusting the intensity of the first magnetic field. When the wire winding 30 and the power source 40 form the second loop, the first adjusting module 50 is located in the second loop and adjusts the current flowing through the second loop thereby adjusting the intensity of the second magnetic field.

The device 1 further includes a path switch 70 for turning on or off the device 1. The path switch 70 is electrically connected between the second adjusting module 60 and the anode 401 of the power source 40. In other embodiment, the path switch 70 can be disposed between the first adjusting module 50 and the cathode 402 of the power source 40, or any suitable place.

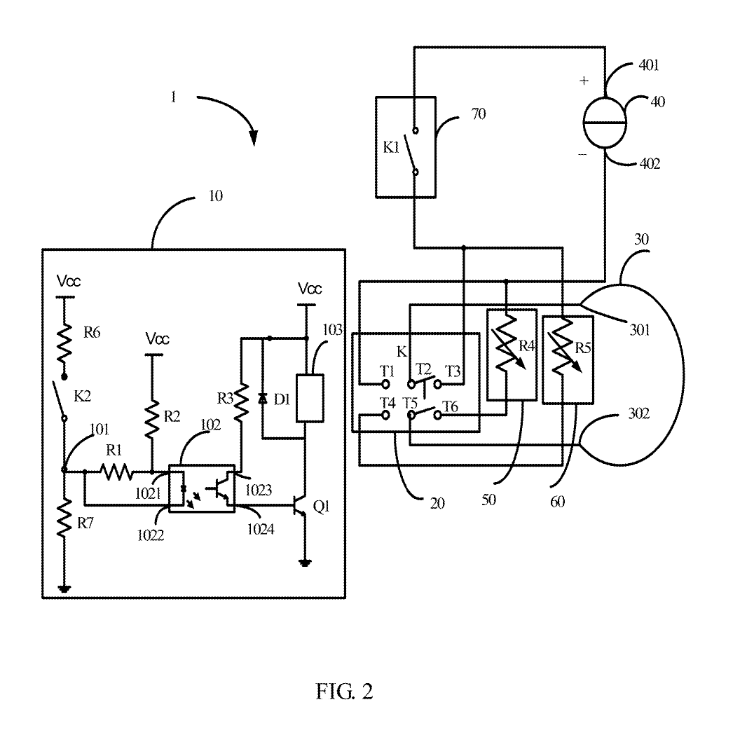

Referring to FIG. 2, in the embodiment, the path control module 10 includes an input port 101, a photo-coupler 102, and a control winding 103. The photo-coupler 102 includes a first input terminal 1021, a second input terminal 1022, a first output terminal 1023, and a second output terminal 1024. The first input terminal 1021 is connected to the input port 101 via a resistor R1, and is also connected to a potential point Vcc via a resistor R2. The second input terminal 1022 is connected to the input port 101. The first output terminal 1023 is connected to the potential point Vcc via a resistor R3. The second output terminal 1024 is connected to a base of a negative-positive-negative (NPN) bipolar junction transistor (BJT) Q1. The control winding 103 is connected between the potential point Vcc and a collector of the NPN BJT Q1. An emitter of the NPN BJT Q1 is grounded. In other embodiments, the NPN BJT Q1 can instead be an n-channel metal-oxide-semiconductor field-effect transistor.

In one embodiment, the path control module 10 further includes a diode D1. The diode D1 and the control winding 103 are connected between the potential point Vcc and the collector of the NPN BJT Q1 in parallel. In one embodiment, the potential point Vcc is connected to the anode of the power source 40 and at high voltage.

In one embodiment, the path switching module 20 is a double-pole double-throw (DPDT) switch K, which combines with the control winding 103 to form a relay. In the embodiment, the relay is a direct current electromagnetic relay.

The DPDT switch K includes two normally closed points T1 and T4, two stationary contact points T2 and T5, and two normally open points T3 and T6. The two stationary contact points T2 and T5 are respectively connected to the first terminal 301 and the second terminal 302 of the wire winding 30. The normally open point T3 is electrically connected to the anode 401 of the power source 40 by the path switch 70, and the normally open point T6 is connected to the cathode 402 of the power source 40 by the first adjusting module 50. The normally closed point T1 is connected to the cathode 402 of the power source 40, and the normally closed point T4 is electrically connected to the anode of the power source 40 by the second adjusting module 60 and the path switch 70. In one embodiment, when the current flows through the control winding 103, the two stationary contact points T2 and T5 are respectively connected to the two normally open points T3 and T6. When no current flows through the control winding 103, the two stationary contact points T2 and T5 are respectively connected to the two normally closed points T1 and T4.

In the circuit, the first adjusting module 50 and the second adjusting module 60 respectively are a rheostat R4 and a rheostat R5. The path switch 70 can be a switch, which a user can operate, such as a push button switch or a toggle switch.

When the input port 101 of the path control module 10 is at low voltage, the first input terminal 1021 of the photo-coupler 102 is at high voltage, and the second input terminal 1022 of the photo-coupler 102, which is electrically connected to the input port 101 is at low voltage. Then the photo-coupler 102 is turned on when there is a voltage between the first input terminal 1021 and the second input terminal 1022, the base of the NPN BJT Q1 is electrically connected to the potential point Vcc by the photo-coupler 102, which is turned on and at high voltage, the NPN BJT Q1 is turned on accordingly. Then the current flows through the control winding 103, and thus, the two stationary contact points T2 and T5 of the DPDT switch K are respectively connected to the two normally open points T3 and T6 of the DPDT switch K.

Therefore, the first terminal 301 of the wire winding 30 is connected to the anode of the power source 40 via the path switch 70, the second terminal 302 of the winding 30 is connected to the cathode of the power source 40 via the first adjusting module 50. The current flows through the wire winding 30 from the first terminal 301 to the second terminal 302, accordingly, the wire winding 30 produces the first magnetic field. When the resistance value of the first adjusting module 50 is adjusted, the current value flowing through the wire winding 30 is changed, and the intensity of the first magnetic field is changed accordingly.

When the input port 101 of the path control module 10 is at high voltage, the first input terminal 1021 and the second input terminal 1022 of the photo-coupler 102 are both at high voltage, then the photo-coupler 102 is turned off. The electrical connection between the potential point Vcc and the base of the NPN BJT Q1 is disconnected, and the NPN BJT Q1 is turned off accordingly. Then no current flows through the control winding 103, and thus, the two stationary contact points T2 and T5 are respectively connected to the two normally closed points T1 and T4.

Therefore, the first terminal 301 of the wire winding 30 is connected to the cathode of the power source 40, the second terminal 302 of the wire winding 30 is connected to the anode of the power source 40 via the second adjusting module 60 and the path switch 70. The current flows through the wire winding 30 from the second terminal 302 to the first terminal 301, accordingly, the wire winding 30 produces the second magnetic field. When the resistance value of the second adjusting module 60 has been adjusted, the current value flowing through the wire winding 30 changes, and the intensity of the second magnetic field changes accordingly.

In the embodiment, the input port 101 of the path control module 10 is further connected to the potential point Vcc via a switch K2 and a resistor R6, and is further connected to ground via a resistor R7. The switch K2 also can be a switch, which a user can operate, such as a push button switch or a toggle switch. When the switch K2 is turned on, the input port 101 of the path control module 10 is connected to the potential point Vcc, and then the input port 101 is at high voltage. When the switch K2 is turned off, the resistor R7 grounds input port 101 of the path control module 10, and then the input port 101 is at low voltage.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A device for producing magnetic field and adjusting magnetic field intensity, comprising:
a power source;
a wire winding;
a path switching module, electrically connected between the power source and the wire winding;
a path control module, configured to control the path switching module to switch the connection between the power source and the wire winding to cause the wire winding and the power source to form a first loop or a second loop, wherein when the first loop being formed, the wire winding produces a first magnetic field, when the second loop being formed, the wire winding produces a second magnetic field;
a first adjusting module, located in the first loop, configured to adjust the intensity of the first magnetic field by adjusting current flowing through the first loop; and
a second adjusting module, located in the second loop, configured to adjust the intensity of the second magnetic field by adjusting current flowing through the second loop.

2. The device according to claim 1, wherein the path switching module is a double-pole double-throw (DPDT) switch, which comprises a first and a second normally closed points, a first and a second stationary contact points, and a first and a second normally open points.

3. The device according to claim 2, wherein the wire winding comprises a first terminal and a second terminal; the first and second stationary contact points are respectively connected to the first terminal and the second terminal of the wire winding; the first normally open point is electrically connected to an anode of the power source, the second normally open point is electrically connected to a cathode of the power source via the first adjusting module; the first normally closed point is connected to the cathode of the power source, and the second normally closed point is electrically connected to the anode of the power source via the second adjusting module.

4. The device according to claim 3, further comprising a path switch connected between the second adjusting module and the anode of the power source, and being configured for turning on or off the device.

5. The device according to claim 3, wherein the path control module comprises an input port, a photo-coupler, and a control winding, a first input terminal of the photo-coupler is connected to the input port via a first resistor, and is further connected to a potential point Vcc via a second resistor; a second input terminal of the photo-coupler is connected to the input port; a first output terminal of the photo-coupler is connected to a potential point via a third resistor; a second output terminal of the photo-coupler is connected to a base of a negative-positive-negative (NPN) bipolar junction transistor (BJT); the control winding is connected between the potential point and a collector of the NPN BJT, and an emitter of the NPN BJT is grounded.

6. The device according to claim 5, wherein the control winding of the path control module combines the DPDT switch to form a relay.

7. The device according to claim 6, wherein when the input port of the path control module is at low voltage, the photo-coupler is turned on, the base of the NPN BJT is electrically connected to the potential point via the photo-coupler which is turned on and at high voltage to cause the NPN BJT to turn on, then there are current flows through the control winding, the first and the second stationary contact points of the DPDT switch are respectively connected to the first and the second normally open points of the DPDT switch, the wire winding and the power source form the first loop.

8. The device according to claim 6, wherein the input port of the path control module is at high voltage, the photo-coupler is turned off, the electrically connection between the potential point and the base of the NPN BJT is disconnected to cause the NPN BJT to turn off, then there are no current flows through the control winding, the first and the second stationary contact points are respectively connected to the first and the second normally closed points, the wire winding and the power source form the second loop.

9. The device according to claim 1, wherein the first adjusting module and the second adjusting module both are rheostat, the first adjusting module and the second adjusting module adjust the intensity of the first magnetic field and the second magnetic field by changing their resistance value.

10. The device according to claim 5, wherein the input port of the path control module is further connected to the potential point via a switch and a fourth resistor, and is further connected to ground via a fifth resistor, when the switch is turned on, the input port of the path control module is at high voltage by connecting the potential point via the fourth resistor and the switch which is turned on; when the switch is turned off, the input port of the path control module is at low voltage by connecting the ground via the fifth resistor.

11. The device according to claim 10, wherein the switch is a push button switch or a toggle switch.

12. The device according to claim 4, wherein the path switch is a push button switch or a toggle switch.
